(19) United States
(12) Patent Application Publication
(10) Pub. No.: US 2023/0351402 A1
(43) Pub. Date: Nov. 2, 2023

(54) MOBILE PLATFORM AUTHENTICATION INTEGRATION INTERACTING WITH TRANSACTION HOST SYSTEM

(71) Applicant: Truist Bank, Charlotte, NC (US)

(72) Inventors: Sudeshna Banerjee, Waxhaw, NC (US); Paul Gerard Mistor, Winston-Salem, NC (US)

(73) Assignee: Truist Bank, Charlotte, NC (US)

(21) Appl. No.: 17/661,438

(22) Filed: Apr. 29, 2022

(51) Int. Cl. G06Q 20/32; G06Q 20/40; G06Q 20/42

(52) U.S. Cl. CPC G06Q 20/322; G06Q 20/401; G06Q 20/425

(57) ABSTRACT

A number of variations may include a mobile user device and back-end server system for remotely authorizing a user of a user mobile device proximate a point of interaction system for real-time transmission of contemporaneous interaction information from the point of interaction system to the user mobile device prior to its periodic deletion by the point of interaction system, the back-end server system non-collocated with both the user mobile device and the point of interaction system.

### FIELD

The present disclosure relates generally to the field of a mobile user device and back-end server system for remotely authorizing a user of the user mobile device proximate a point of interaction system for real-time transmission of contemporaneous interaction information from the point of interaction system and method of providing a client information regarding one of more financial transactions in a client account.

### BACKGROUND

A client of a financial institution may use the electronically obtain some information regarding a financial transaction in an account of the client. However, typically such information is terse, and the client does not have a way to obtain addition information regarding a particular transaction. Usually, a client must make a telephone call to the financial institution and wait to speak to a representative in an attempt to obtain additional information regarding the transaction.

### BRIEF SUMMARY

A number of variations may include a back-end server system for remotely authorizing a user of a user mobile device proximate a point of interaction system for real-time transmission of contemporaneous interaction information from the point of interaction system to the user mobile device prior to its periodic deletion by the point of interaction system, the back-end server system non-collocated with both the user mobile device and the point of interaction system.

The features, functions, and advantages that have been discussed may be achieved independently in various embodiments of the present disclosure or may be combined in yet other embodiments, further details of which can be seen with reference to the following description and drawings, along with the appended claims.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates an enterprise system, and environment thereof, according to at least one embodiment.

FIG. 2 is a flow chart illustrating a method according to a number of variations.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention. The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

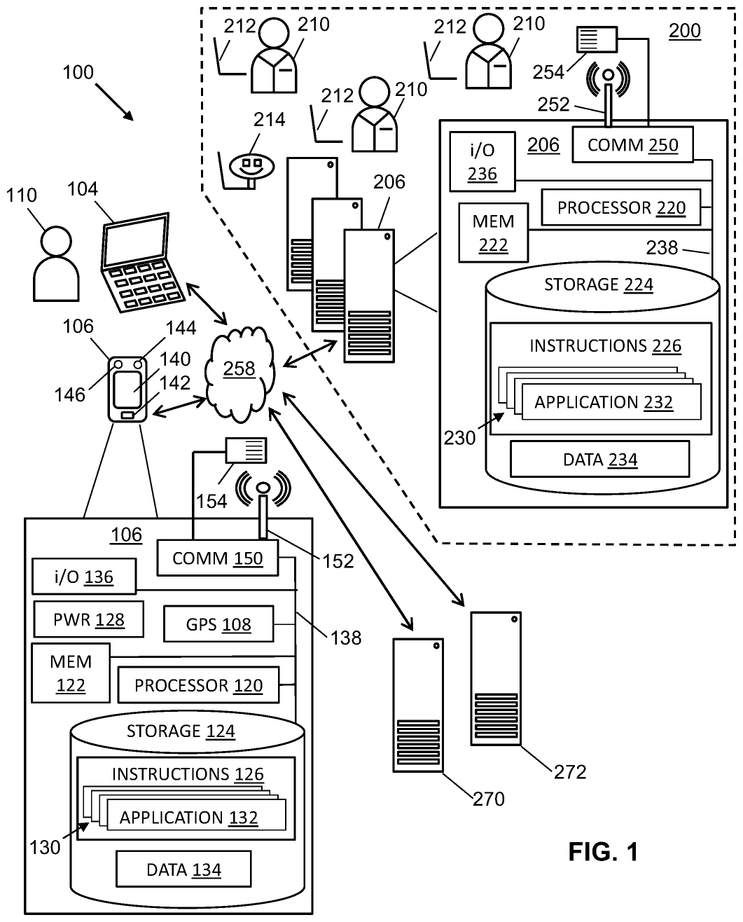

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions. The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like. The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes. System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machnes, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212. Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1. Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 270 and 272 (or 274, and 276, which are not show but may be the same as external systems 270 and 272) are expressly illustrated in FIG. 1, representing any number and variety of data sources, users, consumers, customers, business entities, banking systems, government entities, clubs, and groups of any size are all within the scope of the descriptions. In at least one example, the external systems 270 and 272 represent automatic teller machines (ATMs) utilized by the enterprise system 200 in serving users 110. In another example, the external systems 270 and 272 represent payment clearinghouse or payment rail systems for processing payment transactions, and in another example, the external systems 270, 272, 274, and 276 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 270, 272, 274, and 276 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The financial computer system 206 may store information regarding a transaction in a client account including the date of the transaction and amount of the transaction, and may include an alpha-numeric identification that is in the form the is not a written version of a language spoken by humans, such as English, French, Spanish, Russian, Japanese, Mandarin, Koran, Arabic, Hebrew or the like. In most case, the date of the transaction, amount of the transaction, and/or the alpha-numeric identification may be sufficient or a client's needs. The date of the transaction, amount of the transaction, and/or the alpha-numeric identification may be displayed on a client device 104, 106 as text without hyperlinks or without a means for the client to electronically request or obtain addition information regarding the transaction. There may be millions of client accounts with thousands of transactions in each account in the computer system 206 and it may be advantageous to limit the amount of data stored in the computer system regarding individual transaction. It may be advantageous to operate the computer system 206 to only retrieve additional information when the client device 104, 106 makes an electronic request for additional information. It may be advantageous for the financial computer system 2026 to only stored the additional information temporarily.

In a number of variations, a client device 104, 106 may log into the financial computer system 206 and may electronically transmit a request to the financial computer system for information regarding a transaction in a client account. The financial computer system may electronically transmit a response to the request for information regarding the transaction in the client account. The client may find the response lacking in sufficient information and may use the client device 104, 105 to electronically transmit a request to the financial computer system 206 for additional information regarding the transaction. The financial computer system 206 or an agent device 270, 272, 274, or 276 may transmit additional information to the client device 104, 106 in response to the request for additional information.

In a number of variations, the financial computer system 206 transmitting a request to a first agent device 270 for additional information in response to the received request from the client device for additional information. The financial computer system may receive the additional information and may transmit a response to the client device based on the additional information received.

In a number of variations, the financial computer system 206 may receive the additional information from the first agent device 270. In a number of variations, the first agent 270 may be a retailer associated with the transaction. For example, the retailer may be Amazon, Walmart, Costco, Kroger, BP gasoline station, Western Union of the like.

In a number of variations, financial computer system 206 may receive the additional information from a second agent device 272. In a number of variations, the second agent 272 may be a supplier to a retailer associated with the transaction. For example, the second agent 272 may be another retailer, manufacturer, distributor, or service supplier.

In a number of variations, financial computer system 206 may transmit a request to a third agent device 274 for supplemental information within the additional information. In a number of variations, the supplemental information comprises a description of a product or service associated with a Universal Product Code (UPC) number.

In a number of variations, financial computer system 206 may, in response to receiving a request from the client device 104, 106 for additional information regarding the transaction, redirect the client device to an agent 270, 272, 274, 276 for additional information. The redirection may be a pop-up window displayed on the client device and may require the client device 104, 106 to authorize the redirection to the agent using the client device. In a number of variations, financial computer system 206 may authenticate the client device 104, 106 before redirecting the client device to the agent.

In a number of variations, the client may use the client device 104, 106 to authorize redirection of communications from the financial computer system 206 to a first agent device, second agent device, third agent, or fourth agent device 270, 272, 274, 276 to receive or obtain the additional information or supplemental information regarding the financial transaction.

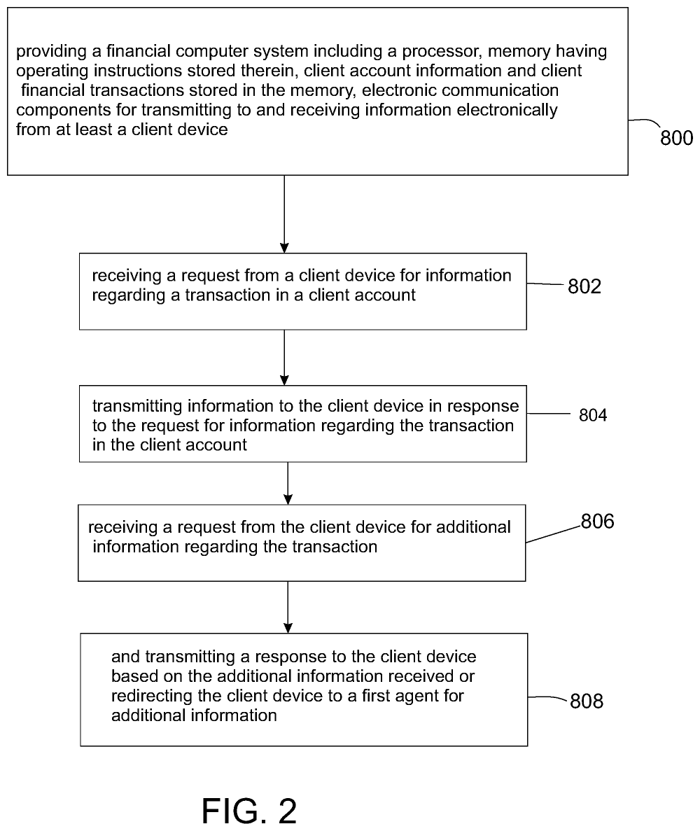

FIG. 2 illustrates a number of variations, which may include a method including providing a financial computer system including a processor, memory having operating instructions stored therein, client account information and client financial transactions stored in the memory, electronic communication components for transmitting to and receiving information electronically from at least a client device 800; receiving a request from a client device for information regarding a transaction in a client account 802; transmitting information to the client device in response to the request for information regarding the transaction in the client account 804; receiving a request from the client device for additional information regarding the transaction 806; and transmitting a response to the client device based on the additional information received or redirecting the client device to a first agent for additional information 808.

A number of variations may include a back-end server system 206 for remotely authorizing a user of a user mobile device 104, 106 proximate a first agent 270 comprising a point of interaction system for real-time transmission of contemporaneous interaction information from the point of interaction system to the user mobile device 104, 106 prior to its periodic deletion by the point of interaction system. The back-end server system 206 non-collocated with both the user mobile device 104, 106 and the point of interaction system 270. The back-end server system may include: at least one processor 220; a communication interface 250 communicatively coupled to the at least one processor 220; and a storage device 224 storing executable code 224. When executed, the stored code 224 causes the processor 220 to: establish a dedicated communication channel between the user mobile device 104, 106 and the back-end server system 206 using a dedicated mobile application 232; receive a transmission, across the dedicated communication channel and from the user mobile device 104, 106, for information regarding an interaction conducted within a predetermined period of time between the user 110 and the point of interaction system 270; transmit information to the user mobile device 104, 106 in response to the transmission for information regarding the interaction; receive a transmission from the user mobile device 104, 106 for additional information regarding the interaction, wherein the additional information regarding the interaction is otherwise unavailable to the user 110; transmit a transmission to the point of interaction system 270 seeking additional information in response to the received transmission from the user mobile device 104, 106 for additional information, wherein the point of interaction system 270 temporarily stores the additional information regarding the interaction prior to deleting the additional information; receive the additional information from the point of interaction system 270; and transmit a response to the user mobile device 104, 106 based on the additional information received, thereby providing the additional information to the user 110, whereby the user 110 would otherwise have no access to the additional information prior to its deletion by the point of interaction system 270.

The executable code 224 may further cause the processor 220 to: send a transmission to the user mobile device 104, 106 seeking authentication credentials for authentication of the user 110 by the back-end server system 206 prior to initiating release of the additional information by transmitting a transmission to the point of interaction system 270 seeking additional information; in response, receive a transmission from the user mobile device 104, 106 including authentication credentials for authentication of the user 110 by the back-end server system 206.

The transmission to the to the user mobile device 104, 106 based upon the additional information received may include at least one of the location of a merchant associated with the transaction, a description of a product or service associated with the transaction, identification of a retailer associated with the transaction, a UPC number, a trademark or trade name.

The received additional information may be from the first agent 270. The first agent 270 may be a retailer associated with the transaction.

The received additional information may be from a second agent device 272. The second agent 272 may be a supplier to a retailer associated with the transaction.

The back-end server system 260 may further transmit a transmission to a third agent device 274 seeking supplemental information within the additional information. The supplemental information may be a description of a product or service associated with a UPC number.

A number of variation may include a method of linking a user mobile device 104, 106 to a first agent 270 comprising a point of interaction system for real-time transmission of contemporaneous interaction information from the point of interaction system 270 to the user mobile device 104, 106 prior to its periodic deletion by the point of interaction system 270, using a back-end server system 206 for remotely authorizing a user 110 of the user mobile device 104, 106. The back-end server system 206 may be non-collocated with both the user mobile device 104, 106 and the point of interaction system 270. The back-end server system 260 may include: at least one processor 220; a communication interface 250 communicatively coupled to the at least one processor 220; and a storage 224 device storing executable code 226. When executed, the stored code 226 causes the processor 220 to: establish a dedicated communication channel between the user mobile device 104, 106 and the back-end server system 206 using a dedicated mobile application 232; receive a transmission, across the dedicated communication channel and from the user mobile device 104, 106, for information regarding an interaction conducted within a predetermined period of time between the user 110 and the point of interaction system 270; transmit information to the user mobile device 104, 016 in response to the transmission for information regarding the interaction; receive a transmission from the user mobile device 104, 106 for additional information regarding the interaction, wherein the additional information regarding the interaction is otherwise unavailable to the user 110; transmit a transmission to the point of interaction system 270 seeking additional information in response to the received transmission from the user mobile device 104, 106 for additional information, wherein the point of interaction system 270 temporarily stores the additional information regarding the interaction prior to deleting the additional information; determining with the back-end server system 206 the first agent 270 associate with the interaction and linking the first agent 270 to the user mobile device 104, 106 so that the first agent 270 may transmit a response to the user mobile device 104, 106 regarding the request for the additional information regarding the interaction.

The executable code 226 may further cause the processor 220 to: send a transmission to the user mobile device 104, 106 seeking authentication credentials for authentication of the user 110 by the back-end server system 206 prior to initiating release of the additional information by transmitting a transmission to the point of interaction system 270 seeking additional information; in response, receive a transmission from the user mobile device 104, 106 including authentication credentials for authentication of the user 110 by the back-end server system 206.

A number of variations may include a mobile user device 104, 206 for remotely being authorized and linked to a back-end server system 206 and/or proximate a first, second, third or fourth agent device 270, 272, 274, 276 (as previously described) comprising a point of interaction system for real-time transmission of contemporaneous interaction information from the point of interaction system to the user mobile device 104, 106 prior to its periodic deletion by the point of interaction system. The back-end server system 206 non-collocated with both the user mobile device 104, 106 and the point of interaction system 270. The mobile user device 104, 106 may include: at least one processor 120; a communication interface 150 communicatively coupled to the at least one processor 120; and a storage device 124 storing executable code 124. When executed, the stored code 124 causes the processor 220 to: establish a dedicated communication channel between the user mobile device 104, 106 and the back-end server system 206 using a dedicated mobile application 232; transmit a transmission, across the dedicated communication channel and to the back-end server system 206, for information regarding an interaction conducted within a predetermined period of time between the user 110 and the point of interaction system 270; receive information from the back-end server system 206 in response to the transmission for information regarding the interaction; transmit a transmission to the back-end server system 206 for additional information regarding the interaction, wherein the additional information regarding the interaction is otherwise unavailable to the user 110 and cause the back-end server system 206 to transmit a transmission to the point of interaction system 270 seeking additional information in response to the received transmission from the user mobile device 104, 106 for additional information, wherein the point of interaction system 270 temporarily stores the additional information regarding the interaction prior to deleting the additional information and wherein the back-end server system 206 receives the additional information from the point of interaction system 270; and receive a response from the back-end server system 206 based on the additional information, thereby providing the additional information to the user 110, whereby the user 110 would otherwise have no access to the additional information prior to its deletion by the point of interaction system 270.

The executable code 124 may further cause the processor 120 to: receive a transmission to the back-end server system 206 seeking authentication credentials for authentication of the user 110 prior to receiving the additional information; in response, transmit a transmission from the user mobile device 104, 106 including authentication credentials for authentication of the user 110 by the back-end server system 206.

The transmission to the to the user mobile device 104, 106 based upon the additional information may include at least one of the location of a merchant associated with the transaction, a description of a product or service associated with the transaction, identification of a retailer associated with the transaction, a UPC number, a trademark or trade name.

The received additional information may be from the first agent 270. The first agent 270 may be a retailer associated with the transaction.

The received additional information may be from a second agent device 272. The second agent 272 may be a supplier to a retailer associated with the transaction.

The mobile user device 104, 106 may further transmit a transmission to the back-end server system 206 or a third agent device 274 seeking supplemental information within the additional information. The supplemental information may be a description of a product or service associated with a UPC number.

What is claimed is:

1. A back-end server system for remotely authorizing a user of a user mobile device proximate a first agent comprising a point of interaction system for real-time transmission of contemporaneous interaction information from the point of interaction system to the user mobile device prior to its periodic deletion by the point of interaction system, the back-end server system non-collocated with both the user mobile device and the point of interaction system, the back-end server system comprising:
at least one processor;
a communication interface communicatively coupled to the at least one processor; and
a storage device storing executable code that, when executed, causes the processor to:
establish a dedicated communication channel between the user mobile device and the back-end server system using a dedicated mobile application;
receive a transmission, across the dedicated communication channel and from the user mobile device, for information regarding an interaction conducted within a predetermined period of time between the user and the point of interaction system;
transmit information to the user mobile device in response to the transmission for information regarding the interaction;
receive a transmission from the user mobile device for additional information regarding the interaction, wherein the additional information regarding the interaction is otherwise unavailable to the user;
transmit a transmission to the point of interaction system seeking additional information in response to the received transmission from the user mobile device for additional information, wherein the point of interaction system temporarily stores the additional information regarding the interaction prior to deleting the additional information;
receive the additional information from the point of interaction system; and
transmit a response to the user mobile device based on the additional information received, thereby providing the additional information to the user, whereby the user would otherwise have no access to the additional information prior to its deletion by the point of interaction system.

2. The back-end server system of claim 1, wherein the executable code further causes the processor to:
send a transmission to the user mobile device seeking authentication credentials for authentication of the user by the back-end server system prior to initiating release of the additional information by transmitting a transmission to the point of interaction system seeking additional information;
in response, receive a transmission from the user mobile device including authentication credentials for authentication of the user by the back-end server system.

3. The back-end server system as set forth in claim 1 wherein the transmission to the based upon the additional information received comprises at least one of the location of a merchant associated with the transaction, a description of a product or service associated with the transaction, identification of a retailer associated with the transaction, a UPC number, a trademark or trade name.

4. The back-end server system as set forth in claim 1 wherein the receive the additional information comprises receive the additional information from the first agent.

5. The back-end server system as set forth in claim 4 wherein the first agent is a retailer associated with the transaction.

6. The back-end server system as set forth in claim 1 wherein the receive the additional information comprises receive the additional information from a second agent device.

7. The back-end server system of set forth in claim 6 wherein the second agent is a supplier to a retailer associated with the transaction.

8. The back-end server system as set forth in claim 1 further comprising transmit a transmission to a third agent device seeking supplemental information within the additional information.

9. The back-end server system as set forth in claim 8 wherein the supplemental information comprises a description of a product or service associated with a UPC number.

10. A method of using a back-end server system for remotely authorizing and linking a user of the user mobile device to at least one agent device comprising a point of interaction system for real-time transmission of contemporaneous interaction information from the point of interaction system to the user mobile device prior to its periodic deletion by the point of interaction system; the back-end server system being non-collocated with both the user mobile device and the point of interaction system; the back-end server system comprising: at least one processor; a communication interface communicatively coupled to the at least one processor; and a storage device storing executable code, when executed, the stored code causes the processor to: establish a dedicated communication channel between the user mobile device and the back-end server system using a dedicated mobile application; receive a transmission, across the dedicated communication channel and from the user mobile device, for information regarding an interaction conducted within a predetermined period of time between the user and the point of interaction system; transmit information to the user mobile device in response to the transmission for information regarding the interaction; receive a transmission from the user mobile device for additional information regarding the interaction, wherein the additional information regarding the interaction is otherwise unavailable to the user; transmit a transmission to the point of interaction system seeking additional information in response to the received transmission from the user mobile device for additional information, wherein the point of interaction system temporarily stores the additional information regarding the interaction prior to deleting the additional information; determining with the back-end server system at least one agent associated with the interaction and linking the at least one agent to the user mobile device so that the at least one agent transmits a response to the user mobile device regarding the request for the additional information regarding the interaction.

11. The method as set forth in claim 10 wherein executable code further causes the processor to: send a transmission to the user mobile device seeking authentication credentials for authentication of the user by the back-end server system prior to initiating release of the additional information by transmitting a transmission to the point of interaction system seeking additional information; in response, receive a transmission from the user mobile device including authentication credentials for authentication of the user by the back-end server system.
